(19) United States
(12) Patent Application Publication
(10) Pub. No.: US 2024/0184528 A1
(43) Pub. Date: Jun. 6, 2024

(54) METHOD FOR GENERATING PSEUDO-RANDOM NUMBER, RANDOM NUMBER GENERATOR, AND COMPUTER-PROGRAM PRODUCT

(71) Applicants: Beijing BOE Technology Development Co., Ltd., Beijing (CN); BOE Technology Group Co., Ltd., Beijing (CN)

(72) Inventors: Xiangye Wei, Beijing (CN); Zhiliang Wang, Beijing (CN)

(73) Assignees: Beijing BOE Technology Development Co., Ltd., Beijing (CN); BOE Technology Group Co., Ltd., Beijing (CN)

(21) Appl. No.: 17/786,486

(22) PCT Filed: Aug. 25, 2021
(86) PCT No.: PCT/CN2021/114595

§ 371 Date: Jun. 16, 2022

(51) Int. Cl. G06F 7/58

(52) U.S. Cl. CPC G06F 7/582

(57) ABSTRACT

A method for generating pseudo-random number is provided. The method includes receiving, by at least one processor, an initial state and a seed; performing, by the at least one processor, at least a cycle of state transfer calculation; and outputting a series of pseudo random numbers. A variable decimal seed is used in at least one step of the at least a cycle of state transfer calculation. The variable decimal seed is calculated in a previous step of the at least a cycle of state transfer calculation.

### TECHNICAL FIELD

The present invention relates to cryptography technology, more particularly, to a method for generating pseudo-random number, a random member generator, and a computer-program product.

### BACKGROUND

Generation of random numbers and pseudo-random numbers has found many applications, including cryptography, secure communication protocols, and video games.

### SUMMARY

In one aspect, the present disclosure provides a method for generating pseudo-random number, comprising receiving, by at least one processor, as initial state and's seed; performing, by the at least one processor, at least a cycle of state transfer calculation; and outputting a series of pseudo random numbers; wherein a variable decimal seed is used in at least one step of the at least a cycle of state transfer calculation; and the variable decimal seed is calculated in a previous step of the at least a cycle of state transfer calculation.

Optionally, performing at least a cycle of state transfer calculation comprises performing (N−1) number of steps of state transfer calculation in a respective cycle to obtain N number of states and N number of bit numbers corresponding to the N number of states, wherein N≤K, K is a maximum possible number of states according to a state transfer function for performing the state transfer calculation, N being an integer equal to or greater than 2, K being an integer equal to or greater than 2.

Optionally, at the end of a (n−1)-th step of the respective cycle, a value U(n) is calculated, 1≤n≤(N−1); an integer part of U(n) is assigned as a n-th state S(n); a decimal part of U(n) is assigned as a n-th variable decimal seed frac(n); wherein, is a n-th step of the respective cycle, S(n) is used as an initial state of the n-th step, and frac(n) is used as an initial variable decimal seed of the n-th step, for calculating a value U(n).

Optionally, the state transfer calculation is performed using a state transfer function expressed as:

$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix}$$

wherein S(n−1) stands for a (n−1)-th state; B_{(S(n-1)} is a bit number corresponding to S(n−1), and has a value of either 0 or 1; r stands for an invariable decimal seed; frac(n−1) stands for a variable decimal seed obtained from a (n−1)-th step; an integer part of U(n) is assigned as the n-th state S(n); and a decimal part of U(n) is assigned as a n-th variable decimal seed frac(n) obtained from a n-th step.

Optionally, performing at least a cycle of state transfer calculation comprises performing M cycles of state transfer calculation, M being an integer equal to or greater than 1.

Optionally, in a m-th cycle, a value of V(m) is obtained in a last step of the m-th cycle, 1≤m<M; an integer part of V(m) is assigned as a m-th state S(m); a decimal past of V(m) is assigned as a m-th variable decimal seed fine (m); wherein, is a (m+1) cycle, S(m) is used as an initial state of the (m+1) cycle, and frac(m) is used as an initial variable decimal seed of the (m+1) cycle.

Optionally, in a first step of a first cycle of state transfer calculation, the state transfer calculation is performed without an input of a variable decimal seed.

Optionally, the method further comprises receiving, by at least one processor, a total number of pseudo random numbers in the series of pseudo random numbers to be outputted.

Optionally, each cycle comprises (N−1) number of steps of state transfer function calculation to generate N number of states and N number of random numbers; M is equal to the total number of pseudo random members in the series divided by N.

Optionally, the series of pseudo random numbers comprises M*N number of bit numbers.

Optionally, the series of pseudo random numbers comprises M*N number of states.

In another aspect, the present disclosure provides a random number generator, comprising a memory; one or more processors; wherein the memory and the one or more processors are connected with each other; and the memory stores computer-executable instructions for controlling the one or more processors to receive an initial state and a seed; perform at least a cycle of state transfer calculation; and output a series of pseudo random numbers; wherein, a variable decimal seed is used in at least one step of the at least a cycle of state transfer calculation; and the variable decimal seed is calculated in a previous step of the at least a cycle of state transfer calculation.

Optionally, to perform at least a cycle of state transfer calculation, the memory stores computer-executable instructions for controlling the one or more processors to perform (N−1) number of steps of state transfer calculation is a respective cycle to obtain N number of states and N number of bit numbers corresponding to the N number of states, wherein N≤K. K is a maximum possible number of states according to a state transfer function for performing the state transfer calculation, N being an integer equal to or greater than 2, K being an integer equal to or greater than 2.

Optionally, at the end of a (n−1)-th step of the respective cycle, a value U(n) is calculated, 1<n≤(N−1); an integer part of U(n) is assigned as a n-th state S(n); a decimal part of U(n) is assigned as a n-th variable decimal seed frac(n); wherein, in a 5-th step of the respective cycle, S(n) is used as an initial state of the n-th step, and frac(n) is used as an initial variable decimal seed of the n-th step, for calculating a value U(n).

Optionally, the state transfer calculation is performed using a state transfer function expressed as:

$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix}$$

wherein S(n−1) stands for a (n−1)-th state; B_{(S(n-1))} is a bit number corresponding to S(n−1), and has a value of either 0 or 1; r stands for an invariable decimal seed; frac(n−1) stands for a variable decimal seed obtained from a (n−1)-th step; an integer part of U(n) is assigned as the n-th state S(n); and a decimal part of U(n) is assigned as a n-th variable decimal seed frac(n) obtained from a n-th step.

Optionally, the memory stores computer-executable instructions for controlling the one or more processors to perform M cycles of state transfer calculation, M being an integer equal to or greater than 1.

Optionally, in a m-th cycle, a value of V(mm) is obtained in a last step of the m-th cycle, 1≤m≤M; as integer part of V(m) is assigned as a m-th state S(m); a decimal part of V(m) is assigned as a m-f variable decimal seed frac (m); wherein, is a (m+1) cycle, S(m) is used as an initial state of the (m+1) cycle, and fac(m) is used as an initial variable decimal seed of the (m+1) cycle.

Optionally, in a first step of a first cycle of state transfer calculation, the state transfer calculation is performed without an input of a variable decimal seed.

Optionally, the memory further stores computer-executable instructions for controlling the one or more processors to receive a total number of pseudo random numbers in the series of pseudo random numbers to be outputted.

Optionally, each cycle comprises (N−1) number of steps of state transfer function calculation to generate N number of states and N number of random numbers; M is equal to the total number of pseudo random numbers in the series divided by N.

Optionally, the series of pseudo random numbers comprises M*N member of bit numbers.

Optionally, the series of pseudo random numbers comprises M*N number of states.

In another aspect, the present disclosure provides a computer-program product comprising a non-transitory tangible computer-readable medium having computer-readable instructions thereon, the computer-readable instructions being executable by a processor to cause the processor to perform receiving, by at least que processor, an initial state and a seed; performing, by the at least one processor, at least a cycle of state transfer calculation; and outputting a series of pseudo random numbers; wherein a variable decimal seed is used in at least one step of the at least a cycle of state transfer calculation; and the variable decimal seed is calculated in a previous step of the at least a cycle of state transfer calculation.

### BRIEF DESCRIPTION OF THE FIGURES

The following drawings are merely examples for illustrative purposes according to various disclosed embodiments and are not intended to limit the scope of the present invention.

FIG. 1 illustrates a series of pseudo-random numbers generated by a method according to the present disclosure.

FIG. 2 illustrates a series of pseudo-random numbers generated by a method according to the present disclosure.

FIG. 3 is a flow chart illustrating a method for generating pseudo-random number in some embodiments according to the present disclosure.

FIG. 4 is a flow chart illustrating a method for generating pseudo-random number in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a method for generating pseudo-random number, a random number generator, and a computer-program product that substantially obviate one or more of the problems due to limitations and disadvantages of the related art. In one aspect, the present disclosure provides a method for generating pseudo-random number. In some embodiments, the method includes receiving, by at least one processor, an initial state and a seed; performing, by the at least one processor, at least a cycle of state transfer calculation; and outputting a series of pseudo random numbers. Optionally, a variable decimal seed is used in at least one step of the at least a cycle of state transfer calculation. Optionally, the variable decimal seed is calculated is a previous step of the at least a cycle of state transfer calculation.

The present method utilizes a state transfer function for generating a series of pseudo-random numbers, with inputs of an initial state and a seed. In some embodiments, other than the seed as an input, the method further uses a variable decimal seed in at least one step of the at least a cycle of state transfer calculation. The variable decimal seed is not part of the initial input, but calculated in a previous step of the state transfer calculation. In one example, in each step of the at least a cycle of state transfer calculation, a variable decimal seed calculated in an immediately adjacent step is used for a present state.

As an example to explain the concept of the present disclosure, a random graph model may be used to describe a system comprising K number of states, among which jumps caw exist. An exemplary random graph model may be expressed as:

$$\{ \begin{matrix}V = \{ 1 , 2 , ⋯ , K \} \\ A = \{ ( i , X ( i ) ) , i = 1 , 2 , ⋯ , K \} ; \\ X ( i ) = j , h = 1 , 2 , ⋯ , K\end{matrix}$$

wherein V stands for a set of vertices of the random graph; A stands for a set of arcs of the random graph, and X(i) stands for an independent random variable.

The sequence of the vertices starts from a first vertex “1” sequentially goes through 1, X(1), x²(1), . . . , to Xⁿ(1), wherein Xⁿ(1)=X(Xⁿ⁻¹(1)). Xⁿ(1) is a vertex that defines a parameter “N” as the first k value by which X^{k}(1) is no longer a new vertex, e.g., at which point no more new states appears in the sequence of the vertices.

As described in the equations below:

j=X^{u} (1);

j=X^{k}(1)=X^{k-u}(j);

The sequence takes a period of u to reach vertex j, and then returns to vertex j again after a period of (k−u). A total time period for the sequence is defined as k. The entire process can be understood as a finite state Markov chain, in which each vertex represents a state. A transfer probability matrix for the finite state Markov chai may be described as:

$$P = [ \begin{matrix}{P}_{11} & {P}_{12} & ⋯ & {P}_{1 K} \\ {P}_{21} & {P}_{22} & ⋯ & {P}_{2 K} \\ ⋮ & ⋮ & ⋮ & ⋮ \\ {P}_{K 1} & {P}_{K 2} & ⋯ & {P}_{KK}\end{matrix} ] .$$

The probability of a n-th step transfer may be obtained using the Chapman-Colmogoros equation:

Pᵢⱼ^{n+m}=Σₖ₌₁⁰PᵢₖⁿPₖⱼ^{m}; or

P^{(n+m)}=P⁽ⁿ⁾·P^{(m)}.

Based on the above, it can be derived that:

p⁽ⁿ⁾=p⁽ⁿ⁻¹⁺¹⁾=pⁿ⁻¹·P=Pⁿ

Accordingly, s same system may hare different cycles.

In the present method, a variable decimal seed is introduced to expand the system.

In some embodiments, performing at least a cycle of state transfer calculation comprises performing (N−1) number of steps of state transfer calculation in a respective cycle to obtain N number of states and N number of bit numbers corresponding to the N number of states, wherein N≤K, K is a maximum possible number of states according to a state transfer function for performing the state transfer calculation.

In a system comprising K number of states, the possible values of N satisfies the following equation:

N∈[1,K],N∈Z.

For example, when K=16, N may be 8.

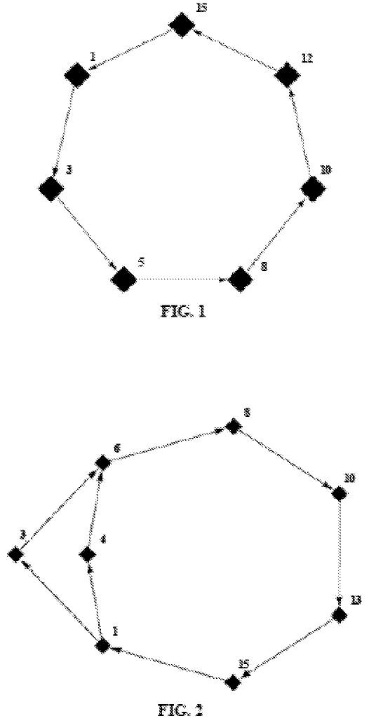

FIG. 1 illustrates a series of pseudo-random numbers generated by a method according to the present disclosure. Referring to FIG. 1, the cycle state transfer calculation includes seven steps, generating a total of 8 states (denoted as 1, 3, 5, 8, 10, 12, 15, and 1). In one example, the state transfer calculation is performed using an initial state of “1” and a seed. The seed may include an integer seed of “2” and an invariable decimal seed of “0.5” (e.g., a r value). Is the example depicted in FIG. 1, the initial state (“1”) is the same as the last state (“1”). Is another example, the maximum possible number (“K”) of states according to a state transfer function may be 16.

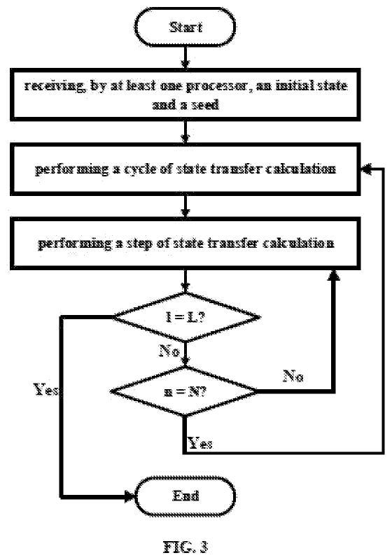

FIG. 2 illustrates a series of pseudo-random numbers generated by a method according to the present disclosure. Referring to FIG. 2, the cycle state transfer calculation includes 9 steps, generating a total of 10 states (denoted as 1, 3, 6, 8, 10, 13, 15, 1, 4, and 6). In one example, the state transfer calculation is performed using an initial state of “1” and a seed. The seed may include an integer seed of “2” and an invariable decimal seed of “0.5” (e.g., a r value). In the example depicted in FIG. 2, the initial state (“1”) is different from the last state (“6”). The random graph includes one or more sub-loops.

In some embodiments, performing a respective cycle of state transfer calculation includes performing (N−1) number of steps of state transfer calculation. In some embodiments, at the end of a (n−1)-th step of the respective cycle, a vale U(n) is calculated, 1≤n≤(N−1). Upon calculation of the value U(n), an integer part of U(n) is assigned as a n-th state S(n); and a decimal part of U(n) is assigned as a n-th variable decimal seed frac(n). To illustrate, and referring to FIG. 1, at the end of the sixth step of the respective cycle, a value 15.75 may be obtained. An integer part of the value 15.75, which is 15, is assigned as the seventh state S(7). A decimal part of the value 15.75, which is 0.75, is assigned as a seventh variable decimal seed frac(7).

In some embodiment, is a n-th step of the respective cycle, S(n) is used as an initial state of the n-th step, and frac(s) is used as an initial variable decimal seed of the n-th step, for calculating a value U(n). Referring to FIG. 1, in the seventh step of the respective cycle, a value of 15, which is assigned as the seventh state S(7), is used as an initial state of the seventh step. A value of 0.75, which is assigned as a seventh variable decimal seed fac(7), is used as as initial variable decimal seed of the seventh step.

In some embodiments, the state transfer calculation is performed using a state transfer function expressed as:

$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix} ;$$

wherein S(n−1) stands for a (n−1)-th state; B_{(S(n-1))} is a bit number corresponding to S(n−1), and has a value of either 0 or 1; r stands for an invariable decimal seed; frac(n−1) stands for a variable decimal seed obtained from a (n−1)-th step.

To illustrate, referring to FIG. 1, in one example, K=16, n=7, and S(n−1) is a sixth state S(6) having a value of 12; B_{(S(n-1))} is a bit number corresponding to S(6); and frac(n−1) is a sixth variable decimal seed frac(6). B_{(S(n-1)} has a value of either 0 or 1. In one example as depicted in FIG. 1, B_{(S(n-1)}=1. Moreover, the seed has a value of 2, and the invariable decimal seed (r) has a value of 0.5. Accordingly, U(n)=(12+1*(0.5+0.75)+2) (mod 16)=15.25. As integer part of 15.25, which is 15, is assigned as the seventh state S(7), and a decimal part of 15.25, which is 0.25, is assigned as the seventh variable decimal seed frac(7).

In some embodiments, an integer part of U(n) is assigned as the n-th state S(n); and a decimal part of U(n) is assigned as a n-th variable decimal seed frac(n) obtained from a n-th step. To illustrate, referring to FIG. 1, the seventh state S(7) would be used as an initial state for the eighth step, and the seventh variable decimal seed frac(7) would be used as the parameter “frac(n−1)” in the seventh step.

Referring to FIG. 1 again, in the seventh step, a value of U(8) is to be calculated according to U(8)=(S(7)+B_{(S(7))}·(r+frac(7))+seed)(mod k). In one example, r=0.5, seed=2, K=16. As discussed in the sixth step, S(7)=15, frac(7)=0.25. In one example as depicted in FIG. 1, B_{(S(7))}=0. Accordingly, U(8)=(15+0*(0.5+0.25)+2) (mod 16)=1.

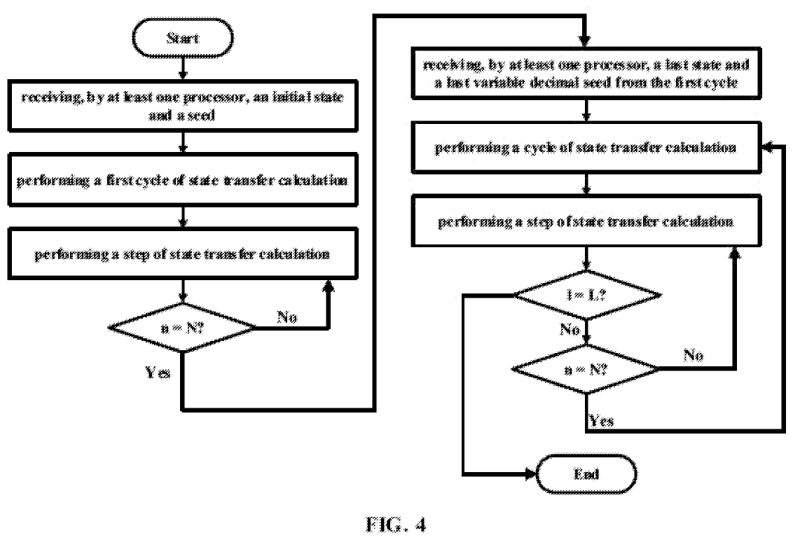

In some embodiments, the method in some embodiments includes performing M cycles of state transfer calculation, M being an integer equal to or greater than 1. FIG. 3 is a flow chart illustrating a method for generating pseudo-random number is some embodiments according to the present disclosure. Referring to FIG. 3, prior to performing M cycles of state transfer calculation, the method includes receiving, by at least one processor, an initial state and a seed (an integer value). Optionally, the method further includes receiving, by at least one processor, an invariable decimal reed (r value). Subsequent to receiving the initial state and the seed, the M cycles of state transfer calculation starts.

In FIG. 3, M=L/N, wherein L represents a total number of pseudo random numbers in the series to be generated; N stands for a number of states in a respective cycle. In one example, a series of a total of 128 pseudo random numbers is to be generated, a respective cycle incudes 8 states (N=8), and s total number of cycles would be 16 (M=16).

Referring to FIG. 3, the method ix some embodiments includes performing a cycle of state transfer calculation. In a respective cycle, the method includes performing a step of state transfer calculation. At the end of each step, if the number of pseudo random numbers, 1 is equal to L, the process ends.

If1<L, and the number of states generated in the respective cycle, n, is less than N, then the method further performs a next step of state transfer calculation in the respective cycle until n=N.

If1<L, and the number of states generated in the respective cycle, n, is equal to N, then the respective cycle ends, and the method further includes performing a next cycle of state transfer calculation. The process is reiterated until 1=L.

In the method illustrated in FIG. 3, in a m-th cycle, a value of V(in) is obtained in a last step of the m-th cycle, 1≤m<M. An integer part of V(m) is assigned as a m-th state S(m). A decimal part of V(m) is assigned as a m-th variable decimal seed frac(m). In a (m+1) cycle, S(m) is used as a initial state of frac(m+1) cycle, and frac(m) is used as an initial variable decimal seed of the (m+1) cycle.

To illustrate, in a fourth cycle of the method, a value of V(4) is obtained in a last step of the fourth cycle. V(m) is equal to U(N) (for example, V(8) when N=8) calculated in the last step of the fourth cycle. In one example, V(4) has a value of 15.25. The integer part of 15.25, which is 15, is used as an initial state in a first step of a fifth cycle (the next cycle). The decimal part of 15.25, which is 0.25, is used as an initial variable decimal seed in the first step of the fifth cycle.

In the method illustrated in FIG. 3, within each cycle of the M cycles, at the end of a (n−1)-th step of the respective cycle, a value U(n) is calculated, 1≤n≤(N−1). Upon calculation of the value U(n), an integer part of U(n) is assigned as a n-th state S(n); and a decimal part of U(n) is assigned as a n-th variable decimal seed frac(n). To illustrate, at the end of the sixth step of the fourth cycle, a value 15.75 may be obtained. An integer part of the value 15.75, which is 15, is assigned as the seventh state S(7). A decimal part of the value 15.75, which is 0.75, is assigned as a seventh variable decimal seed frac(7).

In some embodiment, is each cycle of the M cycles except for the first cycle, a decimal part of V(m) from a previous cycle is used as an initial variable decimal seed in a first step of the present cycle. FIG. 4 is a flow chart illustrating a method for generating pseudo-random number in some embodiments according to the present disclosure. Is FIG. 4, the first cycle (on left side of FIG. 4) of the M cycles is separated from the remaining (M−1) cycles (on right side of FIG. 4). Referring to FIG. 4, the method in some embodiments includes receiving, by at least one processor, an initial state and a seed, and performing a first cycle of state transfer calculation. Performing the first cycle of state transfer calculation includes performing (N−1) steps of state transfer calculation until n=N. As illustrated in FIG. 4, performing the first cycle of state transfer calculation includes performing a step of state transfer calculation, at the end of the step of state transfer calculation, if n is less than N, the method includes performing a next step of state transfer calculation. The process is reiterated until n=N. In one example, an initial variable decimal seed at the first step of the first cycle is not used. At the end of the first step of the fast cycle, a variable decimal seed is generated and is used in the second step of the first cycle as an initial variable decimal seed in the second step. The process is reiterated, for example, at the end of the (N−1)-th step (the last step) of the first cycle, a variable decimal seed is generated and is used as the initial variable decimal seed in the first step of a second cycle.

Referring to FIG. 4, subsequent to the first cycle, the method is some embodiments includes receiving, by at least one processor, a last state and a last variable decimal seed from the first cycle, e.g., from the last step of the first cycle. The last state from the last step of the first cycle is used as an initial state in the second cycle, and the last variable decimal seed from the last step of the first cycle is used as an initial variable decimal seed is a first step of the second cycle. As shown the right side of FIG. 4, the method subsequently includes performing a cycle of state transfer calculation. Is a respective cycle, the method includes performing a step of state transfer calculation. At the end of each step, if the number of pseudo random numbers, 1, is equal to L, the process ends.

If1<L, and the number of states generated in the respective cycle, n, is less than N, then the method further performs a next step of state transfer calculation is the respective cycle until n=N.

If1<L, and the number of states generated in the respective cycle, n, is equal to N, then the respective cycle ends, and the method further includes performing a next cycle of state transfer calculation. The process is reiterated until 1=L.

In FIG. 4, M=L/N, wherein L represents a total number of pseudo random numbers in the series to be generated; N stands for a number of states sa a respective cycle. In one example, a series of a total of 128 pseudo random numbers is to be generated, a respective cycle includes 8 states (N=8), and a total number of cycles would be 16 (M=16). On the left side of FIG. 4, a first cycle is performed. On the right side of FIG. 4, a total of (M−1) cycles (e.g., 15 cycles) are performed.

Optionally, the series of pseudo random numbers comprises M*N number of bit numbers. In one example, the series of pseudo random numbers includes 1, 0, 0, 0, 1, 1, 0, 1, 0, 1, 1, 1, 0.

Optionally, the series of pseudo random numbers comprises M*N number of states. In one example, the series of pseudo random numbers includes 1, 3, 5, 8, 10, 12, 15, 1.

In another aspect, the present disclosure provides a random number generator. Is some embodiments, the random number generator includes a memory; one or more processors. The memory and the one or more processors are connected with each other. In some embodiments, the memory stores computer-executable instructions for controlling the one or more processor to receive an initial state and a seed; perform at least a cycle of state transfer calculation; and output a series of pseudo random numbers. Optionally, a variable decimal wed is used in at least one step of the at least a cycle of state transfer calculation. Optionally, the variable decimal seed is calculated in a previous step of the at least a cycle of state transfer calculation.

In some embodiments, to perform at least a cycle of state transfer calculation, the memory stores computer-executable instructions for controlling the one or more processors to perform (N−1) number of steps of state transfer calculation in a respective cycle to obtain N member of states and N number of bit numbers corresponding to the N number of states. Optionally, N≤K, and K is a maximum possible number of states according to a state transfer function for performing the state transfer calculation, N being an integer equal to or greater than 2, K being an integer equal to or greater than 2.

In some embodiments, at the end of a (n−1)-th step of the respective cycle, a value U(n) is calculated, 1<n≤(N−1). As integer part of U(n) is assigned as a n-th state S(n). A decimal part of U(n) is assigned as a n-th variable decimal seed frac(n). Optionally, in a n-th step of the respective cycle, S(n) is used as an initial state of the n-th step, and frac(n) is used as an initial variable decimal seed of the n-th step, for calculating a value U(n).

In some embodiments, the state transfer calculation is performed using a state transfer function expressed as:

$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix} ;$$

wherein S(n−1) stands for a (n−1)-th state; B_{(S(n-1))} is a bit number corresponding to S(n−1), and has a value of either 0 or 1; r stands for an invariable decimal seed; frac(n−1) stands for a variable decimal seed obtained from a (n−1)-th step. Optionally, an integer part of U(n) is assigned as the n-th state S(n). Optionally, a decimal part of U(n) is assigned as a n-th variable decimal seed frac(n) obtained from a n-th step.

In some embodiments, the memory stores computer-executable instructions for controlling the one or more processors to perform M cycles of state transfer calculation, M being an integer equal to or greater than 1.

In some embodiments, ix a n-th cycle, a value of V(m) is obtained in a last step of the n-th cycle, 1≤m≤M. Optionally, an integer part of V(m) is assigned as a m-th state S(m). Optionally, a decimal part of V(m) is assigned as a m-th variable decimal seed frac(m). Optionally, in a (m+1) cycle, S(m) is used as an initial state of the (m+1) cycle, and frac(m) is used as aw initial variable decimal seed of the (m+1) cycle.

In some embodiment, is a first step of a first cycle of state transfer calculation the state transfer calculation is performed without an input of a variable decimal seed.

In some embodiments, the memory further stores computer-executable instructions for controlling the one or more processors to receive a total number of pseudo random numbers in the series of pseudo random numbers to be outputted.

In some embodiments, each cycle comprises (N−1) number of steps of state transfer function calculation to generate N number of states and N number of random numbers. Optionally. M is equal to the total number of pseudo random numbers in the series divided by N.

Optionally, the senses of pseudo random numbers comprises M*N number of bit numbers. In one example, the series of pseudo random numbers includes 1, 0, 0, 0, 1, 1, 0, 1, 0, 1, 1, 1, 0.

Optionally, the series of pseudo random numbers comprises M*N number of states. In one example, the series of pseudo random numbers includes 1, 3, 5, 8, 10, 12, 15, 1.

In another aspect, the present disclosure further provides a computer-program product comprising a non-transitory tangible computer-readable medium having computer-readable instructions thereon. In some embodiments, the computer-readable instructions are executable by a processor to cause the processor to perform receiving, by at least one processor, an initial state and a seed; performing, by the at least one processor, at least a cycle of state transfer calculation; and outputting a series of pseudo random numbers. Optionally, a variable decimal seed is used in at least one step of the at least a cycle of state transfer calculation. Optionally the variable decimal seed is calculated in a previous step of the at least a cycle of state transfer calculation.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which al terms are meant is their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of de appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

1. A method for generating pseudo-random number, comprising:
receiving, by at least one processor, an initial state and a seed;
performing, by the at least one processor, at least a cycle of state transfer calculation; and
outputting a series of pseudo random numbers;
wherein a variable decimal seed is used in at least one step of the at least a cycle of state transfer calculation; and
the variable decimal seed is calculated in a previous step of the at least a cycle of state transfer calculation.

2. The method of claim 1, wherein performing at least a cycle of state transfer calculation comprises performing (N−1) number of steps of state transfer calculation in a respective cycle to obtain N number of states and N number of bit numbers corresponding to the N number of states, wherein N≤K, K is a maximum possible number of states according to a state transfer function for performing the state transfer calculation, N being an integer equal to or greater than 2, K being an integer equal to or greater than 2.

3. The method of claim 2, wherein, at the end of a (n−1)-th step of the respective cycle, a value U(n) is calculated, 1<n≤ (N−1);
an integer part of U(n) is assigned as a n-th state S(n);
a decimal part of U(n) is assigned as a n-th variable decimal seed frac(n);
wherein, in a n-th step of the respective cycle, S(n) is used as an initial state of the n-th step, and frac(n) is used as an initial variable decimal seed of the n-th step, for calculating a value U(n).

4. The method of claim 1, wherein the state transfer calculation is performed using a state transfer function expressed as:
$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix}$$
wherein S(n−1) stands for a (n−1)-th state; B_{(S(n-1))} is a bit number corresponding to S(n−1), and has a value of either 0 or 1; r stands for an invariable decimal seed; frac(n−1) stands for a variable decimal seed obtained from a (n−1)-th step;
an integer part of U(n) is assigned as the n-th state S(n); and
a decimal part of U(n) is assigned as a n-th variable decimal seed frac(n) obtained from a n-th step.

5. The method of claim 4, wherein performing at least a cycle of state transfer calculation comprises performing M cycles of state transfer calculation, M being an integer equal to or greater than 1.

6. The method of claim 5, wherein, in a m-th cycle, a value of V(m) is obtained in a last step of the m-th cycle, 1≤m<M;
an integer part of V(m) is assigned as a m-th state S(n);
a decimal part of V(m) is assigned as a m-th variable decimal seed frac (m);
wherein, in a (m+1) cycle, S(n) is used as an initial state of the (m+1) cycle, and frac(m) is used as an initial variable decimal seed of the (m+1) cycle.

7. The method of claim 5, wherein, in a first step of a first cycle of state transfer calculation, the state transfer calculation is performed without an input of a variable decimal seed.

8. The method of claim 5, further comprising receiving, by at least one processor, a total number of pseudo random numbers in the series of pseudo random numbers to be outputted.

9. The method of claim 5, wherein each cycle comprises (N−1) number of steps of state transfer function calculation to generate N number of states and N number of random numbers;
M is equal to the total number of pseudo random numbers in the series divided by N.

10. The method of claim 9, wherein the series of pseudo random numbers comprises M*N number of bit numbers.

11. (canceled)

12. A random number generator, comprising:
a memory;
one or more processors;
wherein the memory and the one or more processors are connected with each other; and
the memory stores computer-executable instructions for controlling the one or more processors to:
receive an initial state and a seed;
perform at least a cycle of state transfer calculation; and
output a series of pseudo random numbers;
wherein, a variable decimal seed is used in at least one step of the at least a cycle of state transfer calculation; and
the variable decimal seed is calculated in a previous step of the at least a cycle of state transfer calculation.

13. The random number generator of claim 12, wherein, to perform at least a cycle of state transfer calculation, the memory stores computer-executable instructions for controlling the one or more processors to perform (N−1) number of steps of state transfer calculation in a respective cycle to obtain N number of states and N number of bit numbers corresponding to the N number of states, wherein N≤ K, K is a maximum possible number of states according to a state transfer function for performing the state transfer calculation, N being an integer equal to or greater than 2, K being an integer equal to or greater than 2.

14. The random number generator of claim 13, wherein, at the end of a (n−1)-th step of the respective cycle, a value U(n) is calculated, 1<n≤(N−1);
an integer part of U(n) is assigned as a n-th state S(n);
a decimal part of U(n) is assigned as a n-th variable decimal seed frac(n);
wherein, in a n-th step of the respective cycle, S(n) is used as an initial state of the n-th step, and frac(n) is used as an initial variable decimal seed of the n-th step, for calculating a value U(n).

15. The random number generator of claim 12, wherein the state transfer calculation is performed using a state transfer function expressed as:
$$\{ \begin{matrix}U ( n ) = ( S ( n - 1 ) + {B}_{⌊ s ( π - 1 ) ⌋} \cdot ( r + frac ( n - 1 ) ) + seed ) ( mod K ) \\ {B}_{i} = \{ \begin{matrix}1 , & prob = 0.5 \\ 0 , & prob = 0.5\end{matrix} i ∈ [ 0 , K - 1 ] , i ∈ Z\end{matrix}$$
wherein S(n−1) stands for a (n−1)-th state; B_{(S(n-1))} is a bit number corresponding to S(n−1), and has a value of either 0 or 1; r stands for an invariable decimal seed; frac(n−1) stands for a variable decimal seed obtained from a (n−1)-th step;
an integer part of U(n) is assigned as the n-th state S(n); and
a decimal part of U(n) is assigned as a n-th variable decimal seed frac(n) obtained from a n-th step.

16. The random number generator of claim 12, wherein the memory stores computer-executable instructions for controlling the one or more processors to perform M cycles of state transfer calculation, M being an integer equal to or greater than 1.

17. The random number generator of claim 16, wherein, in a m-th cycle, a value of V(m) is obtained in a last step of the m-th cycle, 1≤ m<M;
an integer part of V(m) is assigned as a m-th state S(n);
a decimal part of V(m) is assigned as a m-th variable decimal seed frac (m);
wherein, in a (m+1) cycle, S(n) is used as an initial state of the (m+1) cycle, and frac(m) is used as an initial variable decimal seed of the (m+1) cycle.

18. The random number generator of claim 16, wherein, in a first step of a first cycle of state transfer calculation, the state transfer calculation is performed without an input of a variable decimal seed.

19. The random number generator of claim 16, wherein the memory further stores computer-executable instructions for controlling the one or more processors to receive a total number of pseudo random numbers in the series of pseudo random numbers to be outputted.

20. The random number generator of claim 16, wherein each cycle comprises (N−1) number of steps of state transfer function calculation to generate N number of states and N number of random numbers;
M is equal to the total number of pseudo random numbers in the series divided by N.

21. (canceled)

22. (canceled)

23. A computer-program product comprising a non-transitory tangible computer-readable medium having computer-readable instructions thereon, the computer-readable instructions being executable by a processor to cause the processor to perform:
receiving, by at least one processor, an initial state and a seed;
performing, by the at least one processor, at least a cycle of state transfer calculation; and
outputting a series of pseudo random numbers;
wherein a variable decimal seed is used in at least one step of the at least a cycle of state transfer calculation; and
the variable decimal seed is calculated in a previous step of the at least a cycle of state transfer calculation.
